(19) United States
(12) Patent Application Publication
(10) Pub. No.: US 2005/0060690 A1
(43) Pub. Date: Mar. 17, 2005

(54) MICROPROCESSOR SYSTEM WITH SOFTWARE EMULATION PROCESSED BY AUXILIARY HARDWARE

(76) Inventors: Kuo-Jung Tung, Chia-Yi Hsien (TW); Meng-Chow Jiang, Tai-Chung City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,196

(22) Filed: Sep. 15, 2003

(51) Int. Cl. G06F 9/44

(52) U.S. Cl. 717/129; 717/134

(57) ABSTRACT

A microprocessor system capable of software debug includes a host computer for executing remote debug, and a program memory for storing a monitor program for proving monitoring of the host computer and a user program. At least one break point address holder temporarily stores a break point address from the host computer. A break point comparator unit is connected to the break point address holder for comparing the break point address from the break point address holder with an address of the user program being executed, and for outputting an interrupt control signal when the addresses match. A controller controls the break point comparator unit, and a microprocessor is electrically connected to the host computer.

### BACKGROUND OF INVENTION

1. Field of the Invention

The present invention relates to a microprocessor system using software to debug, and more specifically, to a microprocessor system with software emulation processed by auxiliary hardware.

2. Description of the Prior Art

As information technology progresses, electronic circuits and microprocessors which process electronic data are rapidly becoming a mainstream of the information industry. In general data processing systems, from mobile phones to personal digital assistants (PDAs) and even personal computers, electronic circuits and applications are required to process digital data. As the gate count and complexity of modern circuit design grows exponentially and as programs become larger in size day-by-day, required debug time has increased significantly. For complicated circuit or program design, debug has become one of the most important steps. In fact, debug now costs the industry more than any other step.

Please refer to FIG. 1 showing a conventional microprocessor system 10 using software to debug. The microprocessor system 10 includes a remote debug host computer 12 for executing remote debug, a program memory 14 for storing a monitor program 16 for providing monitoring, and a user program 18 which is the program to be debugged. The microprocessor system 10 further includes a data memory 20 for storing temporary data generatedwhile executing programs, and a microprocessor 22 connected to the host computer 12 for executing related programs. The microprocessor 22 includes a host interface 24 connected to a transmit port for transmitting signals between the microprocessor and the host computer 12, a program memory address indicator 26 for indicating data in the program memory 14, a data access port 28 for transmitting temporary data generatedwhile executing programs to the data memory 20, and a data memory address pointer 30 for indicating data in the data memory 20.

Please refer to FIG. 2 showing a flowchart of the conventional microprocessor system 10 executing software debug emulation as follows:

Step 100: Input a break point address of the user program 18 to be debugged by the host computer 12 to the microprocessor 22.

Step 102: The microprocessor 22 writes an interrupt trap instruction at an address corresponding to the break point address of the user program 18.

Step 104: The host computer 12 sends out a command to execute the user program 18.

Step 106: When the microprocessor 22 executes the user program 18 until the interrupt trap address, jump to the monitor program 16 and transmit the result of execution to the host computer 12.

Step 108: The host computer 12 restores the user program 18 overwritten by the interrupt trap instruction. Read or change the values of memory and registers in the microprocessor 22 in order to know the status of all hardware and software variables when the program is executed until the break point. Return to Step 100 if further debug is required.

When using the microprocessor 22 to execute the program in the program memory 14, the program memory address pointer 26 indicates data in the program memory 14. The data access port 28 transmits the temporary data generated while executing the program to the data memory 20, and the data memory address pointer 30indicates data in the data memory 20. When executing the monitor program 16 in the program memory 14, the microprocessor 22 waits for the host computer 12 to input the break point address of the user program 18 to be debugged to the microprocessor 22. At this time the user inputs the break point address of the user program 18 to be debugged by the host computer 12 to the microprocessor 22. The microprocessor 22 then writes the interrupt trap instruction into the address corresponding to the break point address of the user program 18. The interrupt trap instruction is commonly a microprocessor jump instruction, the destination address of the jump command being the monitor program 16 so that the monitor program 16 transmits the result of execution back to the host computer 12. In such a manner, the status when the user program 18 is executed until the break point address is known. In addition, if it is desired to continue the execution of the user program 18, it is required to restore the user program 18 overwritten by the interrupt trap command as described in Step102. In other words, to read out a part of the memory to be overwritten and store it in the data memory 20 in advance, and then return it back to the memory and quit the monitor program 16 in order to continue the execution of the user program 16.

However using conventional software debug manner, every time when determining the break point address of the user program 18, it is required to rewrite the program memory 14.Because the instruction the user program 18 in the memory is overwritten by the interrupt trap instruction, and later restored, the program memory 14 requires a higher-cost rewritable memory such as SRAM or DRAM. Therefore, a problem awaiting solution is to improve present microprocessor system.

### SUMMARY OF INVENTION

It is therefore a primary objective of the present invention to provide a microprocessor system with software emulation processed by auxiliary hardware in order to solve the problems mentioned above.

Briefly summarized, a microprocessor system capable of software debug includes a host computer for executing remote debug, a program memory for storing a monitor program for proving monitoring of the host computer, and a user program. At least one break point address holder temporarily stores a break point address from the host computer. A break point comparator unit is connected to the break point address holder for comparing the break point address from the break point address holder with an address of the user program being executed, and for outputting an interrupt control signal when the addresses match. A controller controls the break point comparator unit, and a microprocessor is electrically connected to the host computer. The microprocessor includes a host interface connected to a transmit port of the host computer for transmitting signals between the microprocessor and the host computer. A program memory address pointer used to indicate an address of the program memory and output the address of the user program being executed to the break point comparator unit. Additionally, an interrupt control unit is used for receiving the interrupt control signal from the break point comparator unit. When the interrupt control unit receives the interrupt control signal from the break point comparator unit, the microprocessor executes the monitor program in the program memory in order to transmit the status of execution of the user program to the host computer.

The present invention also provides a method of software debug emulation. The method includes (a) executing a user program, (b) comparing a break point address and an address of the user program being executed, and outputting an interrupt control signal if the break point address matches the address of the user program being executed, and (c) stopping executing the user program and outputting the status of execution of the user program when receiving the interrupt control signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a conventional microprocessor system using software to debug.

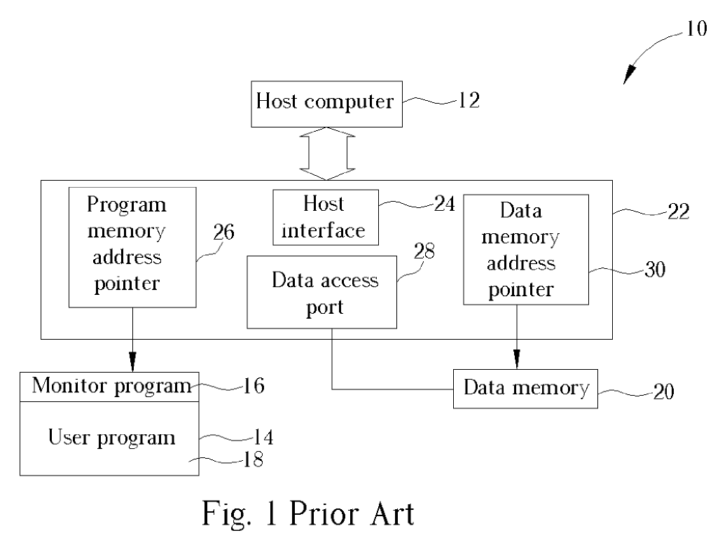

FIG. 2 is a flowchart of the conventional microprocessor system executing software debug emulation.

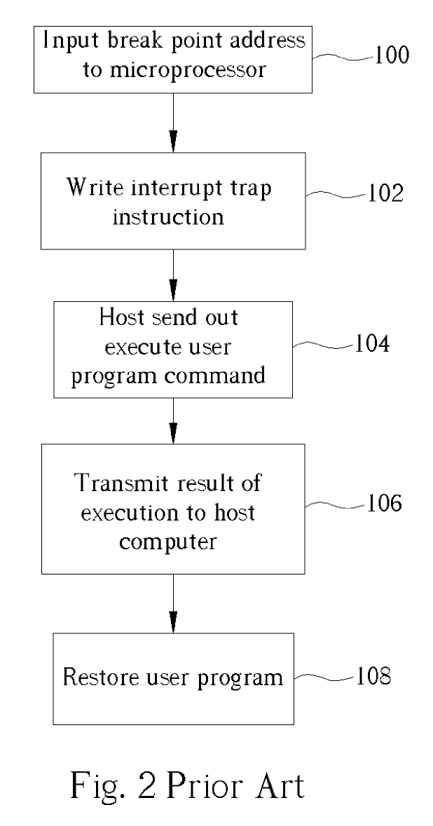

FIG. 3 is a block diagram of a microprocessor system according to the present invention.

FIG. 4 is a flowchart of the microprocessor system executing software debug emulation according to the present invention.

### DETAILED DESCRIPTION

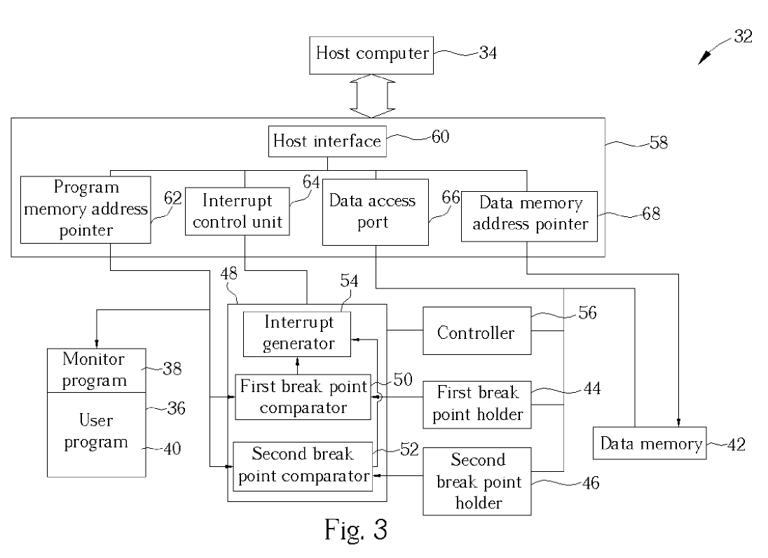

Please refer to FIG. 3 showing a block diagram of a microprocessor system 32 according to the present invention. The microprocessor system 32 includes a remote debug host computer 34 for executing remote debug, a program memory 36, which can be a read-write memory, read-only memory or a flash memory etc., for storing a monitor program 38 for provide monitoring, and a user program 40, which is the program to be debugged. The microprocessor system 32 further includes a data memory 42 for storing temporary data generated while executing programs, a first break point address holder 42 for temporarily storing a first break point address from the host computer 34, a second break point address holder 46 for temporarily storing a second break point address from the host computer 34, and a break point comparator unit 48 for comparing whether the break point address from the host computer 34 and the address of the user program 40 being executed are the same. If the addresses are the same, the break point comparator unit 48 outputs an interrupt control signal. The break point comparator unit 48 includes a first break point comparator 50, which receives the break point address from the first break point address holder 44 and compares it with the address of the user program 40 being executed, a second break point comparator 52, which receives the break point address from the second break point address holder 46 and compares it with the address of the user program 40 being executed, and an interrupt generator 54 for receiving signals from the first break point comparator 50 and the second break point comparator 52 and generating the interrupt control signal. The microprocessor system 32 further includes a controller 56 for controlling the break point comparator unit 48.

The microprocessor system 32 further includes a microprocessor 58 for executing related programs, and the microprocessor 58 includes a host interface 60 connected to a transmit port of the host computer 34 for transmitting signals between the microprocessor 58 and the host computer 34, a program memory address pointer 62 for indicating data in the program memory 36 and outputting the address of the user program 40 being executed to the break point comparator unit 48, an interrupt control unit 64 for receiving the interrupt control signal transmitted by the break point comparator unit 48, a data access port 66 for transmitting temporary data generated while executing programs to the data memory 42, and a data memory address pointer indicator 68 for indicating data in the data memory 42.

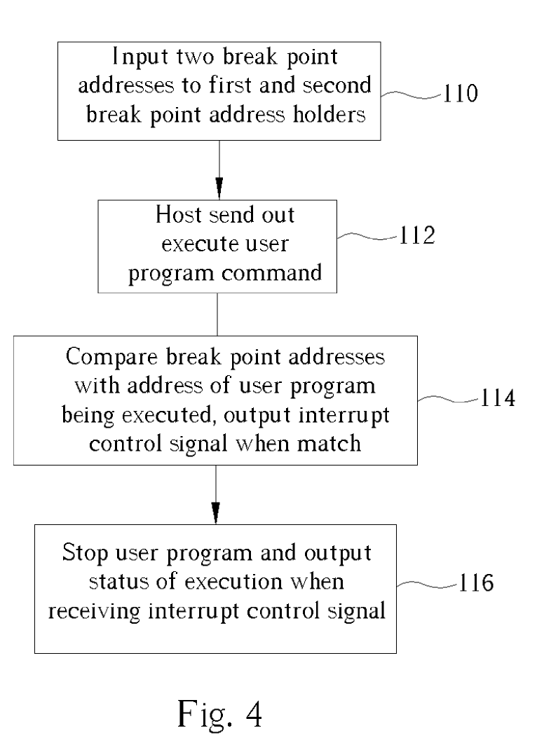

Please refer to FIG. 4 showing a flowchart of the microprocessor system 32 executing software debug emulation according to the present invention. FIG. 4 contains the following steps:

Step 110: Input two break point addresses for the user program 40 to be debugged by the host computer 45 to the first break point address holder 44 and the second break point address holder 46.

Step 112: The host computer 34 sends out a command to execute the user program 40.

Step 114: Use the break point comparator unit 48 to compare the break point addresses from the first break point address holder 44 and the second break point address holder 46 with the address of the user program 40 being executed by the microprocessor 58. If they are the same, output the interrupt control signal to the interrupt control unit 64 in the microprocessor 58.

Step 116: When the interrupt control unit 64 in the microprocessor 58 receives the interrupt control signal, stop executing the user program 40 and output the status of the user program 40 to the host computer 34.

The process according to the present invention is further described as follows. Firstly, when the microprocessor 58 executes the program in the program memory 36, the program memory address pointer 62 indicates data in the program memory 36. The data access port 66 then transmits the temporary data generated while executing the program to the data memory 42. The data memory address pointer 68 indicates data in the data memory 42. While executing the monitor program 38 in the program memory 36, the microprocessor 58 waits for the host computer 34 to input the break point address of the user program 40 to be debugged to the microprocessor 58. The present invention provides two break point address holders, so that two break point addresses of the user program 40 to be debugged can be input at once. The microprocessor 58 then transmits the two break point addresses to the first break point address holder 44 and the second break point address holder 46 respectively through the data access port 66.

The user program 40 is executed after the monitor program 38 receives the execution command. While executing the user program 40, the first break point comparator 50 and the second break point comparator 52 compare the break point addresses from the first break point address holder 44 and the second break point address holder 46 one by one with the address of the user program 40 being executed by the microprocessor 58 as output by the program memory address indicator 62. The result of the comparison is transmitted to the interrupt generator 54 for operation. In other words, when one of the break point addresses from the first break point address holder 44 received by the first break point comparator 50 orone of the break point addresses from the second break point address holder 46 received by the second break point comparator 52 matches the address of the user program 40 being executed, the interrupt generator 54 outputs the interrupt control signal to the interrupt control unit 64 in the microprocessor 58. When the interrupt control unit 64 receives the interrupt control signal from the break point comparator unit 48, the microprocessor 58 stops executing the user program and executes the monitor program 38 in the program memory 36 in order to transmit the result of executing the user program 40 until the address back to the host computer 34. At this time, the host computer 34 can read or change the values of a memory and registers in the microprocessor 58 in order to know the status of all hardware and software variables when the program is executed at the address. During debug, when the microprocessor 58 executes the monitor program 38 to receive the break point address from the host computer 34, the microprocessor 58 generates a control signal to the controller 56 so that the controller 56 activates the break point comparator unit 48. After the microprocessor 58 transmits the status of execution of the user program 40 to the host computer 34, the microprocessor 58 generates a control signal to the controller 56 to turn off the break point comparator unit 48. The steps in FIG. 4 can be repeated if debug is required to be continued.

The microprocessor system 32 according to the present invention provides two break point address holders and two break point comparators, so that the user can store and compare two break point addresses of the user program 40 to be debugged. It is an advantage of the present invention that if the user program 40 includes an instruction with conditional branch, different break points can be set up on the different conditionsbranch instead of on only a single condition branch, so that the program can transmit the result of execution under different executing conditions. However, the microprocessor system 32 according to the present invention is not limited to include only two break point address holders. The number of the break point address holders can be determined according to different requirements, and hereby only one preferred embodiment is described.

In contrast to the prior art, the microprocessor system 32 according to the present invention provides break point address holders for storing the break point addresses of the address to be debugged, so that when the user program 40 is executed, the break point comparator unit 48 compares the break point addresses from the first break point address holder 44 and the second break point address holder 46 with the address of the user program 40 being executed. When one of the break point addresses matches the address of the user program 40 being executed, the break point comparator unit 48 outputs the interrupt control signal to the interrupt control unit 64 of the microprocessor 58 in order to transmit the result of executing the user program 40 at the address back to the host computer 34. In such a manner, it is no longer required to write the interrupt trap instruction at the address corresponding to the input break point address in order to overwrite the original command of the user program, or to read out the command of the user program to be overwrittenin advance and later rewrite it back as is required in the prior art. Therefore, the program memory 36 of the microprocessor system 32 according to the present invention uses a lower-cost read-only memory instead of a higher-cost rewritable memory.

Those skilled in the art will readily observe that numerous modifications and alterations of the device may be made while retaining the teachings of the invention. Accordingly, the above disclosure should be construed as limited only by the metes and bounds of the appended claims.

1. A microprocessor system capable of software debug comprising:
a host computer for executing remote debug;
a program memory for storing a monitor program for proving monitoring of the host computer and a user program;
at least one break point address holder for temporarily storing a break point address from the host computer;
a break point comparator unit connected to the break point address holder for comparing the break point address from the break point address holder with an address of the user program being executed, and for outputting an interrupt control signal when the addresses match;
a controller for controlling the break point comparator unit; and
a microprocessor electrically connected to the host computer comprising:
a host interface connected to a transmit port of the host computer for transmitting signals between the microprocessor and the host computer;
a program memory address pointer for indicating an address of the program memory and outputting the address of the user program being executed to the break point comparator unit; and
an interrupt control unit for receiving the interrupt control signal from the break point comparator unit;
wherein when the interrupt control unit receives the interrupt control signal from the break point comparator unit, the microprocessor executes the monitor program in the program memory in order to transmit the status of execution of the user program to the host computer.

2. The microprocessor system of claim 1, wherein the microprocessor system comprises two break point address holders, and the break point comparator unit comprises two break point comparators which receive and compare the break point addresses from the two break point address holders with the address of the user program being executed from the program memory address pointer; and the microprocessor system further comprises an interrupt generator for receiving signals of the two break point comparators, and outputting a corresponding interrupt control signal to the interrupt control unit.

3. The microprocessor system of claim 1, further comprising a data memory for storing temporary data generated while executing the program.

4. The microprocessor system of claim 3, wherein the microprocessor further comprises a data memory address pointer for indicating data in the data memory.

5. The microprocessor system of claim 1, wherein the microprocessor further comprises a data access port for transmitting the break point address transmitted from the host computer to the break point address holder, and for transmitting a control signal to the controller.

6. The microprocessor system of claim 1, wherein the host computer is a computer device.

7. The microprocessor system of claim 1, wherein the program memory is a read-only memory.

8. The microprocessor system of claim 1, wherein the program memory is a read/write memory.

9. A method of software debug emulation comprising:
(a) executing a user program;
(b) comparing a break point address and an address of the user program being executed, and outputting an interrupt control signal if the break point address matches the address of the user program being executed; and
(c) stopping executing the user program and outputting the status of the user program when receiving the interrupt control signal.

10. The method of claim 9, wherein in step (c), when receiving the interrupt control signal, a monitor program is executed to output the status of the user program.

11. A device for implementing the method of claim 9.
